(19) United States
(12) Patent Application Publication
(10) Pub. No.: US 2020/0192269 A1
(43) Pub. Date: Jun. 18, 2020

(54) IMAGE FORMING APPARATUS

(71) Applicant: KONICA MINOLTA, INC., Tokyo (JP)

(72) Inventors: Kenji TAMAKI, Tokorozawa-shi (JP); Masashi SUGANO, Tokyo (JP); Yoshihito SASAMOTO, Tokyo (JP); Kenji YAMAMOTO, Tokyo (JP)

(21) Appl. No.: 16/717,047

(22) Filed: Dec. 17, 2019

(30) Foreign Application Priority Data
Dec. 17, 2018 (JP) 2018-235056

(51) Int. Cl. G03G 15/00

(52) U.S. Cl. CPC G03G 15/80; G03G 2215/00978; G03G 15/5004

(57) ABSTRACT

An image forming apparatus includes a high-voltage power supply board utilized for electrophotographic image formation, wherein a converter that generates high voltage is arranged on the high-voltage power supply board, and a drive coil and a high-voltage generation coil in the converter are insulated from each other, a first hardware processor that generates a control signal to control the drive coil is provided, the first hardware processor generates the control signal suitably adjusted in accordance with each of various alternating waveforms, and high voltage having various alternating waveforms is output from one output terminal of the converter of the high-voltage power supply board.

### CROSS REFERENCE TO RELATED APPLICATIONS

The present invention claims priority under 35 U.S.C. § 119 to Japanese patent Application No. 2018-235056, filed on Dec. 17, 2018, is incorporated herein by reference in its entirety.

### BACKGROUND

### Technological Field

The present invention relates to an image forming apparatus, and more particularly relates to an image forming apparatus including a high-voltage power supply board utilized for electrophotographic image formation.

### Description of the Related Art

An image forming apparatus such as a multi-functional peripherals (MFP) that electrophotographically forms an image includes a high-voltage power supply circuit to apply high voltage during charging, developing, and transferring. In a conventional high-voltage power supply circuit, output control is performed by using part of functions of a central processing unit (CPU) that performs total control (particularly engine control) of the apparatus. This output control requires a control signal and a feedback (FB) signal, and signals are exchanged between the high-voltage power supply circuit and the CPU.

Generally, the control board on which the CPU that performs total control (particularly, engine control) for the apparatus is mounted is separated from a high-voltage power supply board on which the high-voltage power supply circuit is formed, and a wiring path between the boards may be long in length. Due to this, a component to reliably transmit a signal is arranged. For example, a control signal is sent out from the CPU as a pulse width modulation (PWM) signal in order to remove influence of noise, and converted into an analog signal by using a converter in the high-voltage power supply board. Also, since an FB signal is an analog signal, the signal is amplified by an amplifier in order to increase a signal-to-noise (SN) ratio, and sent out from the high-voltage power supply board. Then, noise is removed by a filter provided on a receiving side of the control board on which the CPU is mounted.

As for such a high-voltage power supply, for example, JP 2007-295722 A discloses a high-voltage power supply device that generates high voltage to be supplied to at least one of charging bias, developing bias, and transfer bias used inside an electrophotographic image forming apparatus. The high-voltage power supply device includes: a piezoelectric transformer that outputs high voltage in accordance with a frequency of a drive pulse; a drive pulse generator that generates the drive pulse; a frequency controller that controls a frequency of the drive pulse generated by the drive pulse generating means; a voltage detector that detects an output voltage of the piezoelectric transformer. The frequency controller sequentially and stepwisely increases or decreases the frequency of the drive pulse generated by the drive pulse generator, and when it is detected that a voltage value obtained by the voltage detector exceeds a peak, a frequency in one step before this voltage value exceeding the speak is set as an operation lower limit frequency, and the frequency of the drive pulse generated by the drive pulse generator is controlled to become the operation lower limit frequency or higher during operation of the image forming apparatus.

As described above, a high-voltage power supply is utilized during charging, developing, transferring, and the like in an image forming apparatus that electrophotographically forms an image. However, problems as follows may occur in utilizing the high-voltage power supply.

For example, a description will be provided for the problem in the case of utilizing the high-voltage power supply for secondary transfer at the time of transferring, to a sheet, a toner image formed on a transfer belt. Conventionally, secondary transfer voltage is DC voltage, and toner can be uniformly transferred onto a flat sheet by the DC voltage. However, the toner cannot be uniformly transferred by the DC voltage onto a sheet which has been applied with processing such as embossing and has irregularities because an electric field is concentrated on an edge portion of the irregularities. For such a situation, a circuit that generates an alternating (AC) component having a predetermined waveform is formed, and the AC component is added to the DC voltage to move the toner such that the toner is uniformly transferred onto the sheet having the irregularities. However, kinds of irregularities of sheets are various, and a single kind of waveform cannot cope with such various kinds of sheets. To solve such a problem, a method of forming, on the high-voltage power supply board, a plurality of circuits to generate various waveforms can be considered. However, this method has a problem that a configuration of the high-voltage power supply board becomes complex.

### SUMMARY

The present invention is made in view of the above-described problems, and is mainly directed to providing an image forming apparatus capable of outputting high voltage having various waveforms with a simple configuration.

To achieve the abovementioned object, according to an aspect of the present invention, an image forming apparatus reflecting one aspect of the present invention comprises a high-voltage power supply board utilized for electrophotographic image formation, wherein a converter that generates high voltage is arranged on the high-voltage power supply board, and a drive coil and a high-voltage generation coil in the converter are insulated from each other, a first hardware processor that generates a control signal to control the drive coil is provided, the first hardware processor generates the control signal suitably adjusted in accordance with each of various alternating waveforms, and high voltage having various alternating waveforms is output from one output terminal of the converter of the high-voltage power supply board.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view illustrating a configuration of an image forming apparatus according to an example of the present invention;

FIG. 2A to FIG. 2C are block diagrams illustrating the configuration of the image forming apparatus according to the example of the present invention;

FIG. 3 is a circuit diagram illustrating a configuration of a high-voltage power supply board according to the example of the present invention;

FIG. 4 is a circuit diagram illustrating another configuration of the high-voltage power supply board according to the example of the present invention;

FIG. 5 is a schematic diagram illustrating alternating waveforms output from an output terminal of the high-voltage power supply board according to the example of the present invention;

FIG. 6A and FIG. 6B are diagrams to describe high-voltage power supply control according to the example of the present invention, FIG. 6A illustrates waveforms in an entire sheet, and FIG. 6B illustrates a waveform for one period;

FIG. 7A to FIG. 7C are diagrams to describe the high-voltage power supply control according to the example of the present invention, FIG. 7A illustrates waveforms in an entire sheet, and FIG. 7B and FIG. 7C each illustrate a waveform for one period; and

FIG. 8 is a circuit diagram illustrating a configuration of a conventional high-voltage power supply board.

### DETAILED DESCRIPTION OF EMBODIMENTS

Hereinafter, one or more embodiments of the present invention will be described with reference to the drawings. However, the scope of the invention is not limited to the disclosed embodiments.

As described in the related art, an image forming apparatus such as an MFP that electrophotographically forms an image includes a high-voltage power supply circuit to apply high voltage during charging, developing, and transferring, and output control is performed by using part of functions of a CPU that performs total control (particularly, engine control) for the apparatus. Generally, a control board on which the CPU that performs the total control for the apparatus is mounted is separated from the high-voltage power supply board, and a wiring path may be long in length. Therefore, a converter is arranged on a transmission path of a control signal, and an amplifier and/or a filter are/is arranged in a transmission path of the FB signal that is an analog signal (in a case of making an FB signal into a PWM signal, a converter is arranged).

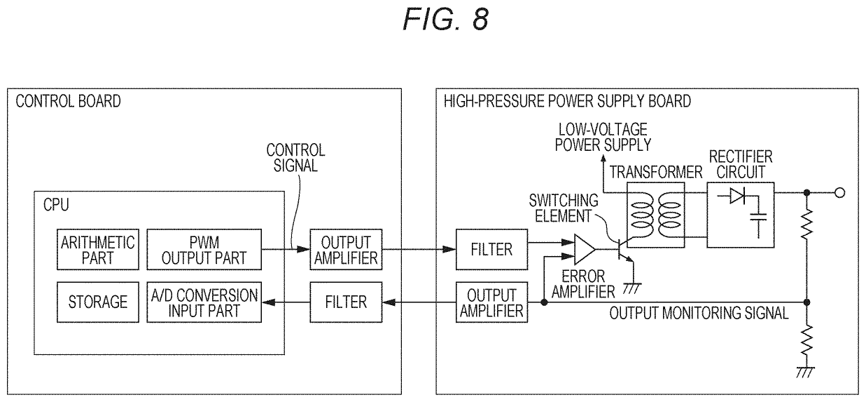

This conventional high-voltage power supply circuit will be described with reference to FIG. 8. The high-voltage power supply circuit in FIG. 8 is a circuit that outputs secondary transfer voltage by so-called feedback control, and is controlled by the CPU of the control board. The high-voltage power supply board includes a filter, an output amplifier, an error amplifier, a switching element, a transformer, and a rectifier circuit. Additionally, the control board includes a CPU, an output amplifier, and a filter. The CPU includes an arithmetic part, a storage, a PWM output part, and an A/D conversion input part.

In this high-voltage power supply board, a primary coil of the transformer has one end connected to a low-voltage power supply (for example, a power supply that supplies DC voltage of 24V), and has the other end connected to a collector terminal of a transistor. A secondary coil of the transformer is connected to the rectifier circuit. The transistor is used as a switching element that switches the primary coil of the transformer. The transistor has a base terminal connected to the PWM output part of the CPU in the control board via the filter on the high-voltage power supply board and the output amplifier on the control board, and has an emitter terminal grounded.

The PWM output part of the CPU in the control board is a circuit that outputs a drive pulse to turn on/off the transistor, and modulates a pulse width of the drive pulse in accordance with an arithmetic result of the arithmetic part.

The transistor becomes conductive (turned on) when the drive pulse is ON, and becomes non-conductive (turned off) when the drive pulse is OFF. Therefore, when an ON time of the drive pulse becomes long, energy accumulated in the primary coil of the transformer is increased, and the output voltage from the secondary coil can be increased. In contrast, when an OFF time of the drive pulse becomes short, the output voltage from the secondary coil can be decreased.

The rectifier circuit includes a diode, a capacitor, and the like, and rectifies and smooths AC voltage output from the secondary coil of the transformer, and outputs the AC voltage to an output terminal. Additionally, the rectifier circuit has the output terminal grounded via a series circuit of two resistors, and voltage divided by the two resistors is received as an output monitoring signal in the A/D conversion input part of the CPU in the control board via the output amplifier on the high-voltage power supply board and the filter on the control board.

The CPU in the control board samples the output monitoring signal, acquires a difference between a voltage value thereof and a value (target value) preliminarily acquired as voltage to be received in the A/D conversion input part while assuming that a prescribed voltage (such as 2000 V) is output. Then, the CPU changes a duty ratio of a control signal output from the PWM output part so as to minimize the difference, and executes feedback control such that the output voltage is kept at the prescribed voltage.

Additionally, the control signal output from the PWM output part and the output monitoring signal are received in the error amplifier, and voltage obtained by amplifying a voltage difference between the two signals is output.

The above-described high-voltage power supply board outputs high voltage having a single waveform. However, a preferable waveform to uniformly transfer toner is different in accordance with a sheet type. Therefore, this conventional high-voltage power supply board cannot cope with various types of sheets (particularly, a sheet that has been applied with processing such as embossing and has irregularities). Additionally, in the configuration of outputting the high voltage having the single waveform, it is difficult to cope with not only changes in the sheet type but also changes in media information such as basis weight, environmental information like a temperature and a humidity, and state information like a conveyance speed, a sheet position, a transfer method, and paper information. To solve such a problem, a method of forming, on the high-voltage power supply board, a plurality of circuits to generate various waveforms can be considered. However, this method has a problem that a configuration of the high-voltage power supply board becomes complex.

Furthermore, the high-voltage power supply board is usually arranged at a position close to a load, and the control board is arranged at a center portion of the apparatus. Therefore, a distance between the high-voltage power supply board and the control board is long in length, thereby causing noticeable signal delay. Particularly, switching of high-voltage output is required to be performed at a higher speed in order to improve an apparatus speed and cope with various types of sheets in recent years. However, in a case where time constants are generated at connection points of respective functions, response delay may occur, and the switching may not be able to be performed as required.

For example, there is a requirement to shorten an output switching time between sheets at secondary transfer part due to increase in a linear speed, and the output voltage needs to be switched between 100V and 5000V in 1 msec. However, in the above-described conventional structure, the output monitoring signal is received in the CPU via the output amplifier at an output port of the high-voltage power supply board and the filter at an input port of the control board, and the control signal output from the CPU is output to the high-voltage power supply circuit via the output amplifier at an output port of the control board and the filter at an input port of the high-voltage power supply board. As a result, a time constant of about 2 msec is generated at each output amplifier or filter, and therefore, it is not possible to satisfy the requirement to perform the voltage switching in 1 msec.

Furthermore, due to multi-functionalization of the image forming apparatus in recent years, the apparatus has a more complex structure, and routing of wiring also becomes more complex. As a result, noise is easily carried on a signal, and malfunction of the apparatus is likely to occur.

To solve such a situation, according to one embodiment of the present invention, an image forming apparatus including a high-voltage power supply board utilized for electrophotographic image formation has a structure in which: a converter that generates high voltage is arranged on a high-voltage power supply board; a drive coil and a high-voltage generation coil in the converter are insulated from each other; only one high-voltage output terminal is provided; high voltage having various alternating waveforms can be output from one output terminal of the converter, and a CPU that generates a control signal suitably adjusted in accordance with each of the various alternating waveforms is arranged in the high-voltage power supply board.

Additionally, in the high-voltage power supply board, since a switching element is connected to the drive coil, a rectifier circuit is connected to the high-voltage generation coil, the one output terminal is connected to the rectifier circuit, and the CPU drives the switching element based on the control signal, the high voltage having the various alternating waveforms can be output from the one output terminal. Furthermore, since the switching element of a push-pull configuration is connected to the drive coil, the one output terminal is connected to the high-voltage generation coil directly or via a connection circuit, and the CPU drives the switching element based on the control signal, the high voltage having the various alternating waveforms can be output from the one output terminal. Note that, in the present specification, the high voltage represents voltage defined in the technical standards for electric installation, and in a case of alternating current, the high voltage represents voltage higher than 600 V and 7000 V or less. Additionally, the alternating waveform represent a waveform in which waveform amplitude is periodically changed, and includes a case where the waveform amplitude is periodically changed in a positive region or a negative region (more specifically, a polarity is not periodically changed).

Thus, since the high voltage having the various alternating waveforms can be output from the one output terminal, it is possible to cope with changes in the environmental information, the state information, and the medium information with a simple configuration. Furthermore, since the CPU is arranged in the high-voltage power supply board, the switching of the high voltage output can be performed at the high speed.

### EXAMPLE

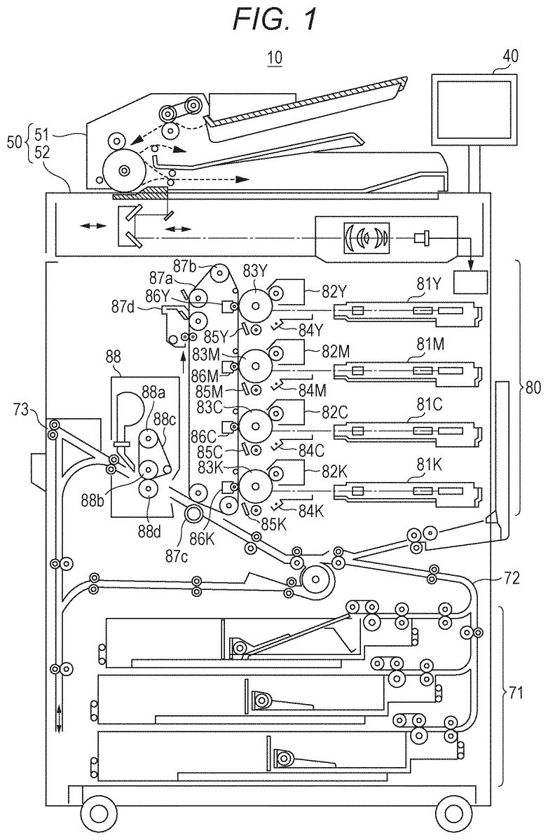

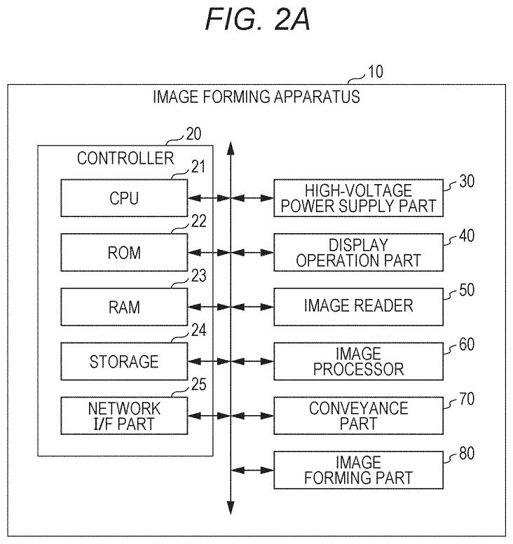

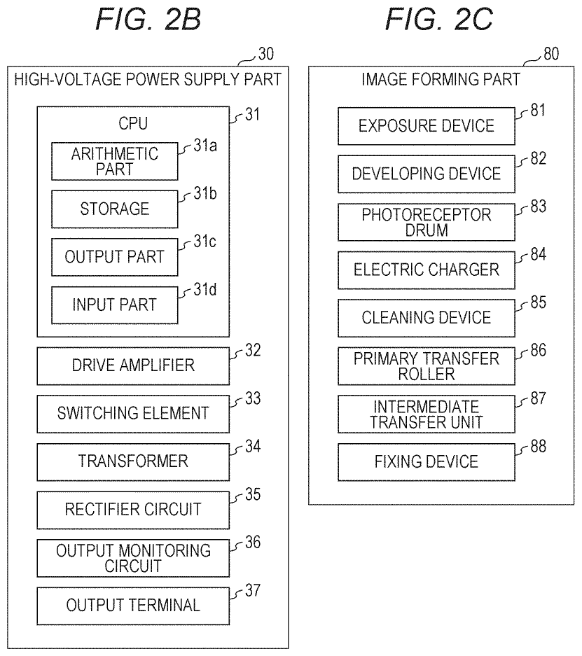

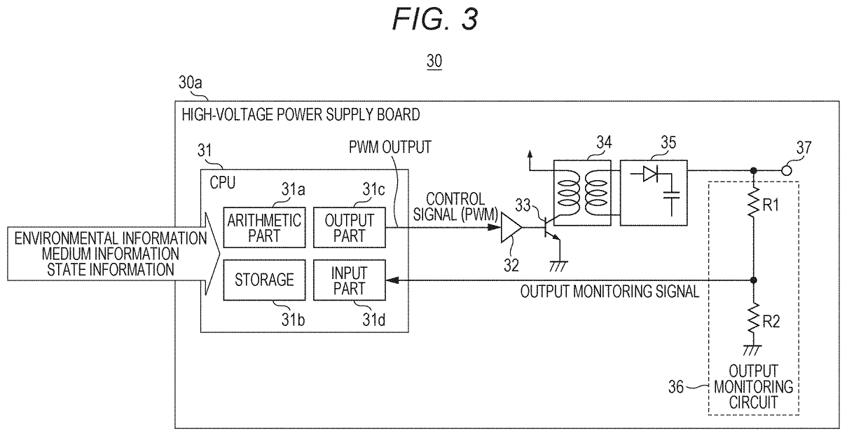

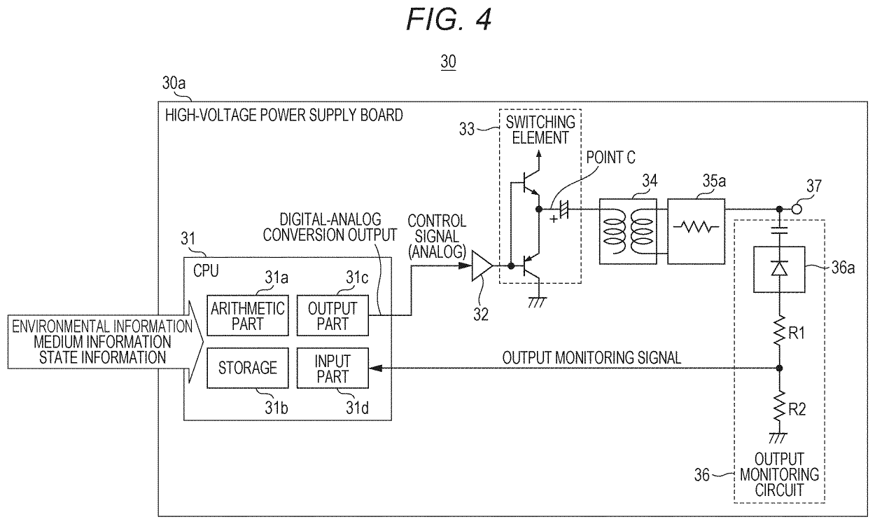

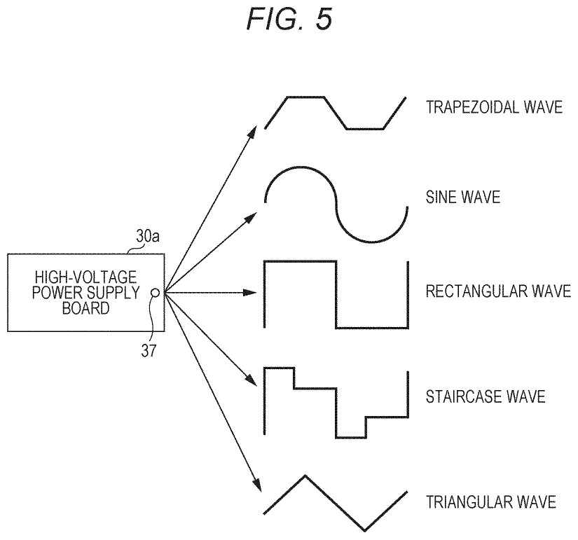

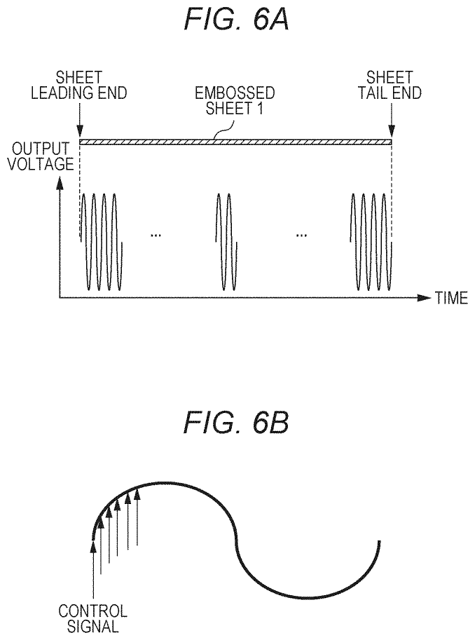

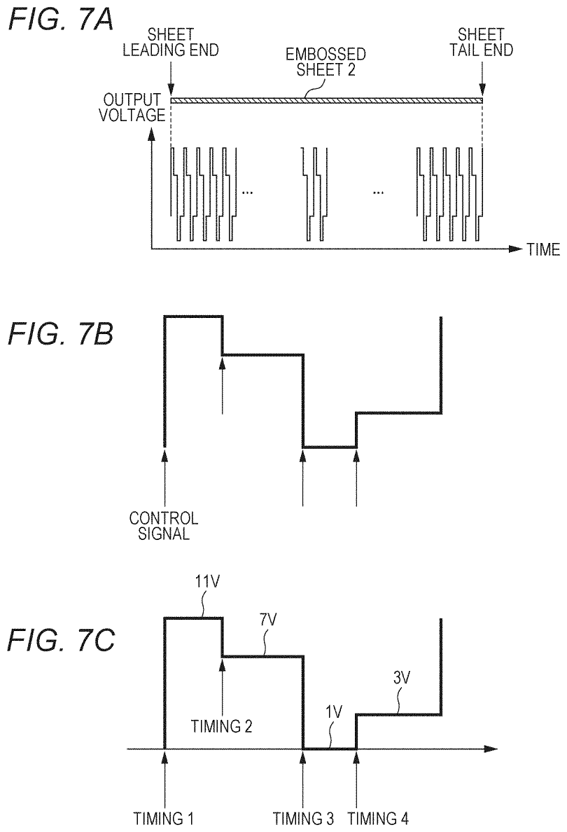

To describe more specifically the above-described embodiment of the present invention, an image forming apparatus according to an example of the present invention will be described with reference to FIG. 1 to FIG. 7C. FIG. 1 is a schematic view illustrating a configuration of an image forming apparatus according to the present example, and FIG. 2A to FIG. 2C are block diagrams illustrating the configuration of the image forming apparatus. Additionally, FIG. 3 and FIG. 4 are circuit diagrams each illustrating a configuration of a high-voltage power supply board of the present example, and FIG. 5 is a schematic diagram illustrating alternating waveforms output from the high-voltage power supply board. Furthermore, FIG. 6A, FIG. 6B and FIG. 7A to FIG. 7C are schematic diagrams to describe high-voltage power supply control of the present example.

As illustrated in FIG. 1, an image forming apparatus 10 according to the present example is an apparatus that forms an image by superimposing colors on a sheet based on image data acquired by reading a document or image data received from an external information device (such as a client device) via a communication network, and also is a tandem type image forming apparatus in which photoreceptor drums 83Y, 83M, 83C, and 83K as photoreceptors corresponding to four colors, for example, yellow (Y), magenta (M), cyan (C), and black (K) are arranged in series in a travel direction of a transfer object (intermediate transfer belt).

As illustrated in FIG. 2A, the image forming apparatus 10 includes a controller 20, a high-voltage power supply part 30, a display operation part 40, an image reader 50, an image processor 60, a conveyance part 70, an image forming part 80, and the like.

The controller 20 includes: a central processing unit (CPU) 21, a memory such as a read only memory (ROM) 22 and a random access memory (RAM) 23; a storage 24 such as a hard disk drive (HDD) or a solid state drive (SSD); a network I/F part 25 such as a network interface card (NIC) or a modem; and the like. The CPU 21 reads out a program corresponding to processing content from the ROM 22 or the storage 24, develops and executes the program in the RAM 23. Thus, the CPU executes centralized control for operation in each of the parts of the image forming apparatus 10. The storage 24 stores: a program used for the CPU 21 to control each of the parts; information associated with processing functions of the own apparatus; image data read by the image reader 50; image data received from a client device (not illustrated); and the like. The network I/F part 25 connects the image forming apparatus 10 to a communication network such as a local area network (LAN) or a wide area network (WAN), and exchanges various kinds of data with an external information device (such as the client device).

The high-voltage power supply part 30 is a circuit that generates high voltage utilized during charging, developing, and transferring, and outputs the high voltage having various alternating waveforms from one output terminal to an electric charger 84, a developing device 82, a primary transfer roller 86, and an intermediate transfer unit 87 described later. For example, secondary transfer is executed by: converting DC voltage of 24V into transfer voltage; and outputting the converted transfer voltage to a secondary transfer roller. A detailed configuration of the high-voltage power supply part 30 will be described later.

The display operation part 40 includes a touch panel, such as a liquid crystal display (LCD) or an electro luminescence (EL) display, on which transparent electrodes are arranged in a lattice-like form and an operation device (touch sensor) of a pressure-sensitive type, a capacitance type, or the like is provided. The display operation part 40 functions as a display part and an operation part. The display part displays various kinds of operation screens, states of an image, operation states of each of the functions, and the like in accordance with display control signals received from the controller 20. The operation part receives various kinds of input operation by a user, and outputs operation signals to the controller 20.

The image reader 50 includes an automatic document feeding device 51 called an auto document feeder (ADF), a document image scanning device (scanner) 52, and the like. The automatic document feeding device 51 conveys a document placed on a document tray by a conveyor and sends out the document to the document image scanning device 52. The document image scanning device 52 optically scans the document conveyed from the automatic document feeding device 51 onto a contact glass or a document placed on the contact glass, and reads a document image by forming, on a light receiving surface of a charge coupled device (CCD), an image of reflection light emitted from the document. The image (analog image signal) read by the image reader 50 is subjected to predetermined image processing in the image processor 60.

The image processor 60 includes: a circuit that performs analog-digital (A/D) conversion processing; a circuit that performs digital image processing; and the like. The image processor 60 generates digital image data by applying the A/D conversion processing to the analog image signal from the image reader 50. Additionally, the image processor 60 analyzes a print job acquired from the external information device (such as the client device), rasterizes each page of the document, and generates digital image data. Then, the image processor 60 applies processing such as color conversion processing, correction processing (shading correction, and the like), and compression processing to the image data as necessary, and outputs the image data that has been applied with the image processing to the image forming part 80.

As illustrated in FIG. 1, the conveyance part 70 includes a sheet feeding device 71, a conveyor 72, a sheet ejection device 73, and the like. In the present example, the sheet feeding device 71 includes three sheet feeding trays. In these sheet feeding trays, standard sheets and special sheets identified based on basis weight, a size, and the like of each of the sheets are stored in a manner categorized in preset sheet types. The sheets stored in each of the sheet feeding trays are sent one by one from an upper most sheet, and are conveyed to the image forming part 80 by the conveyor 72 including a plurality of conveyance rollers such as registration rollers. At this time, a registration part provided with the registration rollers corrects skew of each of the fed sheets, and adjusts conveyance timing. Additionally, a sheet on which an image has been formed by the image forming part 80 is ejected to a sheet ejection tray outside the apparatus by the sheet ejection device 73 including sheet ejection rollers.

As illustrated in FIG. 1 and FIG. 2B, the image forming part 80 includes an exposure device 81 (81Y, 81M, 81C, or 81K), the developing device 82 (82Y, 82M, 82C, or 82K), the photoreceptor drum 83 (83Y, 83M, 83C, or 83K), the electric charger 84 (84Y, 84M, 84C, or 84K), a cleaning device 85 (85Y, 85M, 85C, or 85K), and the primary transfer roller 86 (86Y, 86M, 86C, or 86K) in a manner corresponding to the different color components Y, M, C, and K, and further includes the intermediate transfer unit 87, a fixing device 88, and the like. Note that reference signs without Y, M, C, and K will be used as necessary in the following description.

Each of the photoreceptor drums 83 of the respective color components Y, M, C, and K is an image carrier in which an organic photosensitive layer (OPC) including an overcoat layer as a protective layer is formed on an outer peripheral surface of a cylindrical metal body made of an aluminum material. The photoreceptor drum 83 is driven by the intermediate transfer belt described later in the grounded state, and rotated in a counterclockwise direction in FIG. 1.

The electric charger 84 of each of the color components Y, M, C, and K is a scorotron type, and is arranged in the vicinity of the corresponding photoreceptor drum 83 in a state in which a longitudinal direction of each of the electric chargers is set along a rotational axis direction of each of the photoreceptor drums 83. A surface of each of the photoreceptor drums 83 is applied with uniform potential by corona discharge with a polarity same as that of toner. During the electric charge, the various alternating waveforms are output from the one output terminal of the high-voltage power supply part 30 as necessary.

The exposure device 81 for each of the color components Y, M, C, and K forms an electrostatic latent image by: performing scanning in parallel to the rotational axis of the photoreceptor drum 83 with, for example, a polygon mirror or the like; and executing image exposure based on image data on the surface of the corresponding photoreceptor drum 83 uniformly charged.

The developing device 82 of each of the color components Y, M, C, and K contains a two-component developer including toner having a small particle size of the corresponding color component and a magnetic material. The developing device conveys the toner onto the surface of the photoreceptor drum 83 to visualize the electrostatic latent image carried by the photoreceptor drum 83 with the toner. During this development, the various alternating waveforms are output from the one output terminal of the high-voltage power supply part 30 as necessary.

The primary transfer roller 86 of each of the color components Y, M, C, and K presses the intermediate transfer belt against each of the photoreceptor drums 83, and performs primary transfer onto the intermediate transfer belt by sequentially superimposing toner images of the respective colors formed on the corresponding photoreceptor drums 83. During this primary transfer, the various alternating waveforms are output from the one output terminal of the high-voltage power supply part 30 as necessary.

The cleaning device 85 of each of the color components Y, M, C, and K collects residual toner remaining on the corresponding photoreceptor drum 83 after the primary transfer. Additionally, a lubricant applicator (not illustrated) is provided adjacent to each of the cleaning devices 85 on a downstream side in a rotation direction of the corresponding photoreceptor drum 83, and coats a photosensitive surface of the photoreceptor drum 83 with the lubricant.

The intermediate transfer unit 87 includes an endless intermediate transfer belt 87a that is to be a transfer target, a plurality of support rollers 87b, a secondary transfer roller 87c, an intermediate transfer cleaning unit 87d, and the like, and the intermediate transfer belt 87a is stretched between the plurality of support rollers 87b. The intermediate transfer belt 87a on which the toner images of the respective colors have been primarily transferred by the primary transfer rollers 86Y, 86M, 86C and 86K is pressed against a sheet by the secondary transfer roller 87c. As a result, the toner image is secondarily transferred onto the sheet and conveyed to the fixing device 88. The intermediate transfer cleaning unit 87d includes a belt cleaning blade (hereinafter referred to as a BCL blade) that is in contact with a surface of the intermediate transfer belt 87a in a slidable manner. The transfer residual toner remaining on the surface of the intermediate transfer belt 87a after the secondary transfer is scraped off and removed by the BCL blade. During this secondary transfer, the various alternating waveforms are output from the one output terminal of the high-voltage power supply part 30 as necessary.

The fixing device 88 includes a heating roller 88a functioning as a heat source, a fixing roller 88b, a fixing belt 88c passed around these rollers, a pressure roller 88d, and the like. The pressure roller 88d is pressed against the fixing roller 88b via the fixing belt 88c, and this pressed portion forms a nip portion. Then, a sheet that has passed through the nip portion is heated and pressed by the fixing belt 88c heated by the heating roller 88a and the respective rollers. Thus, an unfixed toner image formed on the sheet is fixed.

Then, the sheet on which the toner image has been fixed by the fixing device 88 is ejected to the sheet ejection tray outside the apparatus by the sheet ejection device 73 including the sheet ejection rollers.

Next, the configuration of the high-voltage power supply part 30 will be described with reference to FIG. 3. As illustrated in FIG. 3, the high-voltage power supply part 30 of the present example includes, in the high-voltage power supply board 30a, a CPU 31, a drive amplifier 32, a switching element 33, a transformer (converter) 34, a rectifier circuit 35, and an output monitoring circuit 36, and an output terminal 37. Additionally, the CPU 31 includes an arithmetic part 31a, a storage 31b, an output part 31c, and an input part 31d.

The transformer 34 has a structure in which a primary coil (drive coil) and a secondary coil (high-voltage generation coil) are insulated from each other. The primary side coil (drive coil) has one end connected to a low-voltage power supply (such as a power supply that supplies DC voltage of 24V), and has the other end connected to a collector terminal of the transistor. The secondary coil (high-voltage generation coil) is connected to the rectifier circuit 35. The transistor is used as the switching element 33 that switches the primary coil of the transformer, has a base terminal connected to the drive amplifier 32, and has an emitter terminal grounded.

The output part (PWM output part) 31c of the CPU 31 is a circuit that outputs a drive pulse (control signal) to turn on/off the transistor, and modulates a pulse width of the drive pulse in accordance with an arithmetic result of the arithmetic part 31a. The transistor becomes conductive (turned on) when the drive pulse is ON, and becomes non-conductive (turned off) when the drive pulse is OFF. Therefore, when an ON time of the drive pulse is longer, an output voltage from the secondary coil can be made higher. In contrast, when an OFF time of the drive pulse is shorter, the output voltage from the secondary coil can be made lower.

The control signal (PWM signal) output from the output part 31c is received in the drive amplifier 32 and amplified, and the amplified control signal is received in a base terminal of the switching element 33. Note that, in a case where the switching element 33 can be driven by the control signal output from the output part 31c, the drive amplifier 32 can be omitted. Then, voltage is applied to the drive coil in accordance with switching operation of the switching element 33, and high voltage having an alternating waveform synchronized with a drive frequency of the switching element 33 is generated from the high-voltage generation coil.

The rectifier circuit 35 is a circuit including a diode, a capacitor, and the like, and converts, into DC current, the high voltage that has been output from the high-voltage generation coil and has the alternating waveform. Then, the rectifier circuit 35 outputs the DC current to the image forming part 80 from the output terminal 37 arranged in the high-voltage power supply board 30a. In the present example, the number of output terminal 37 is one, and the control signal in which the duty ratio of the drive pulse is changed is output from the output part 31c. Thus, the high voltage having the various alternating waveforms can be output from the one output terminal 37. For example, as illustrated in FIG. 5, a trapezoidal wave, a sin wave, a rectangular wave, a staircase wave, a triangular wave, and the like can be output. Meanwhile, a drive frequency of the switching element 33 is 60 kHz to 100 kHz. Therefore, the rectifier circuit 35 is formed as a circuit such that a time constant is 17 μsec or more and 170 μsec or less to smooth the frequency.

Additionally, the high output voltage of the output terminal 37 is received in the input part 31d of the CPU 31 as an output monitoring signal through resistance voltage division of the output monitoring circuit 36 including resistors R1 and R2. The arithmetic part 31a of the CPU 31 calculates an error from the output monitoring signal and performs output control. For example, the CPU samples the output monitoring signal, and acquires a difference between a voltage value thereof and a voltage value (target value) to be received in the input part 31d while assuming that a prescribed voltage is output. Then, the CPU changes the duty ratio of the control signal output from the output part 31c so as to minimize the difference, and executes feedback control such that the output voltage is kept at the prescribed voltage.

The CPU 31 of the high-voltage power supply part 30 having the above-described configuration functions as a high voltage output controller that controls high-voltage output based on information output from the CPU 21 in the board (control board) of the controller 20 that controls the entire image forming apparatus. This information includes environmental information, medium information, state information, and the like. The environmental information includes a temperature, a humidity, and the like. The medium information includes a sheet type (e.g., high-quality embossed sheet), basis weight (e.g., 128 g/m²), and the like. The state information includes a conveyance speed (e.g., 600 mm/sec), a sheet position (e.g., a leading edge/rear edge of a sheet), a transfer method (single-side/double sides), and paper information (for example, an embossed type).

In the following, a case of executing output control for the secondary transfer by using the above information will be described with reference to FIG. 6A and FIG. 6B. FIG. 6A is a diagram illustrating voltage output to the secondary transfer roller 87c when a sheet passes through the nip portion, and FIG. 6B is an enlarged diagram of an alternating waveform for one period. For example, in a case where the environmental information indicates a low temperature and a low humidity (LL), the medium information (sheet type) indicates an embossed sheet 1, the medium information (basis weight) indicates 128 g/m², and the state information (transfer method) indicates the single side, the high-voltage power supply part 30 outputs, from the output terminal 37, high voltage having an alternating waveform suitable for these conditions. Here, the embossed sheet 1 has little (small) irregularities and toner can be easily dispersed. Therefore, a sin wave is output.

At this time, the CPU 31 changes a command value at timing indicated by each arrow in FIG. 6B (when the output voltage is gradually increased, the duty ratio of the control signal is gradually increased) to control on/off of the switching element 33. Note that the arithmetic part 31a of the CPU 31 may calculate the control signal for one period of each alternating waveform as necessary such that the output part 31c outputs the control signal calculated by the arithmetic part 31a, or a control signal for one period of each alternating waveform may be preliminarily stored in the storage 31b of the CPU 31 such that the output part 31c outputs the control signal stored in the storage 31b.

Next, a case of starting secondary transfer onto a subsequent sheet after completion of the secondary transfer to the embossed sheet 1 will be described with reference to FIG. 7A to FIG. 7C. FIG. 7A is a diagram illustrating voltage output to the secondary transfer roller 87c when the sheet passes through the nip portion, and FIG. 7B is an enlarged view of an alternating waveform for one period. For example, in a case where the environmental information indicates a low temperature and a low humidity (LL), the medium information (sheet type) indicates an embossed sheet 2, the medium information (basis weight) indicates 128 g/m², and the state information (transfer method) indicates single-side transfer, the high-voltage power supply part 30 outputs, from the output terminal 37, high voltage having an alternating waveform suitable for these conditions. Here, since the embossed sheet 2 has many (a large amount of) irregularities, and the toner can be hardly dispersed. Therefore, a staircase wave is output.

At this time, the CPU 31 changes a command value (the duty ratio of the control signal) at timing indicated by each arrow in FIG. 7B to control on/off of the switching element 33. Note that, in this case also, the arithmetic part 31a of the CPU 31 may calculate the control signal for one period of each alternating waveform as necessary such that the output part 31c outputs the control signal calculated by the arithmetic part 31a, or a control signal for one period of each alternating waveform may be preliminarily stored in the storage 31b of the CPU 31 such that the output part 31c outputs the control signal stored in the storage 31b.

In a case where the above-described embossed sheet 1 and embossed sheet 2 are alternately conveyed, an alternating waveform in the high-voltage output is required to be changed in accordance with shapes of the irregularities because the embossed sheet 1 and the embossed sheet 2 have the different shapes of irregularities. However, the high-voltage power supply part 30 of the present example can output the high voltage having the various alternating waveforms from the one output terminal 37 by changing the duty ratio of the control signal. Therefore, the high voltage having the various alternating waveforms can be output with a simple configuration. Furthermore, the high-voltage power supply part 30 of the present example outputs the control signal from the CPU 31 in the high-voltage power supply board 30a. Therefore, signal delay can be suppressed, the high-voltage output can be switched at the high speed, and malfunction caused by noise can be suppressed.

In the above, the high-voltage power supply part 30 having the configuration of FIG. 3 is used to output the high voltage having the various alternating waveforms. However, as far as the high-voltage power supply part 30 can output the high voltage having the various alternating waveforms from the one output terminal 37, the configuration as illustrated in FIG. 4 can also be used, for example.

A difference 1 from the configuration in FIG. 3 is that the output part 31c in the CPU 31 includes a digital/analog conversion output part, and can output a linear analog control signal. Note that an analog control signal is more likely to be affected by noise than a PWM signal is. However, the high-voltage power supply part 30 of the present example can use the analog control signal because the CPU 31 is included in the high-voltage power supply board 30a and a distance from the CPU 31 to the drive amplifier 32 (or the switching element 33) is short.

A difference 2 from the configuration in FIG. 3 is that the switching element 33 that drives the drive coil of the transformer 34 includes a push-pull circuit (pure complementary class B push-pull circuit), and a polarity of current flowing in the drive coil can be alternately changed. Since the switching element 33 includes the push-pull circuit, DC voltage is output from the high-voltage generation coil. Therefore, there is no need to provide the rectifier circuit 35 in a post stage of the transformer 34. Note that, in the present example, a connection circuit 35a for short-circuit protection is provided in a post stage of the high-voltage generation coil.

A difference 3 from the configuration in FIG. 3 is that a diode array 36a is connected to the output monitoring circuit 36, and unidirectional alternating voltage can be extracted by the diode array 36a. An output monitoring signal is generated through resistance division, and received in the input part 31d of the CPU 31.

In the case where the staircase wave illustrated in FIG. 7A is output by using the high-voltage power supply part 30 having the configuration illustrated in FIG. 4, drive control for the drive amplifier 32 is performed as illustrated in FIG. 7C at a point C in FIG. 4 (an output stage of the push-pull circuit). Specifically, a command value (the duty ratio of the control signal) is changed such that the voltage becomes 11 V at timing 1, 7 V at timing 2, 1 V at timing 3, and 3 V at timing 4. At this time, assuming that a winding ratio between the drive coil and the high-voltage generation coil is defined as 100, the voltage is sequentially output to the output terminal 37 in the order of 1100 V→700 V→100 V→300 V at respective timing synchronized with the timing 1 to 4.

As described above, since the high voltages having the various alternating waveforms can be output from the one output terminal 37, it is possible to cope with changes in the environmental information, the medium information, and the state information with the simple configuration. Furthermore, since the CPU 31 is arranged in the high-voltage power supply board 30a, high-voltage output can be switched at the high speed, and malfunction caused by noise can be suppressed.

Note that the present invention is not limited to the above-described example, and the configuration and the control can be modified as appropriate within the scope not departing from the gist of the present invention.

For example, in the above example, the high-voltage power supply control in the image forming apparatus has been described, but the high-voltage power supply control of the present invention can also be similarly applied to an arbitrary apparatus in which a high-voltage power supply board and a control board are separately arranged due to a structure of the apparatus.

The present invention is applicable to an image forming apparatus including a high-voltage power supply board utilized for electrophotographic image formation.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising a high-voltage power supply board utilized for electrophotographic image formation, wherein
a converter that generates high voltage is arranged on the high-voltage power supply board, and a drive coil and a high-voltage generation coil in the converter are insulated from each other,
a first hardware processor that generates a control signal to control the drive coil is provided,
the first hardware processor generates the control signal suitably adjusted in accordance with each of various alternating waveforms, and
high voltage having various alternating waveforms is output from one output terminal of the converter of the high-voltage power supply board.

2. The image forming apparatus according to claim 1, wherein
the first hardware processor is arranged in the high-voltage power supply board.

3. The image forming apparatus according to claim 1, wherein
in the high-voltage power supply board,
a switching element is connected to the drive coil,
a rectifier circuit is connected to the high-voltage generation coil,
the rectifier circuit is connected to the one output terminal, and
the first hardware processor outputs the high voltage having the various alternating waveforms from the one output terminal by driving the switching element based on the control signal.

4. The image forming apparatus according to claim 1, wherein
in the high-voltage power supply board,
a switching element having a push-pull configuration is connected to the drive coil,
the one output terminal is connected to the high-voltage generation coil directly or via a connection circuit, and
the first hardware processor outputs the high voltage having the various alternating waveforms from the one output terminal by driving the switching element based on the control signal.

5. The image forming apparatus according to claim 1, wherein
in the high-voltage power supply board,
a circuit that generates an output monitoring signal to monitor output of the high voltage is connected to the output terminal, and the output monitoring signal is received in the first hardware processor.

6. The image forming apparatus according to claim 2, further comprising a control board that controls the image forming apparatus, wherein
the first hardware processor in the high-voltage power supply board generates the control signal based on information output from a second hardware processor in the control board.

7. The image forming apparatus according to claim 6, wherein
the first hardware processor in the high-voltage power supply board controls output of the high voltage based on information output from the second hardware processor in the control board.

8. The image forming apparatus according to claim 6, wherein
the first hardware processor in the high-voltage power supply board calculates the control signal for one period of each alternating waveform as necessary, and outputs the calculated control signal.

9. The image forming apparatus according to claim 6, wherein
the first hardware processor in the high-voltage power supply board stores the control signal for one period of each alternating waveform, and outputs the stored control signal.

10. The image forming apparatus according to claim 1, wherein
the alternating waveform is selected from a trapezoidal wave, a sin wave, a rectangular wave, a staircase wave, and a triangular wave.
